(19) United States
(12) Patent Application Publication
(10) Pub. No.: US 2026/0157267 A1
(43) Pub. Date: Jun. 11, 2026

(54) HARVESTING MACHINE FOR ROOT CROPS, AND RECEIVING UNIT FOR A HARVESTING MACHINE

(71) Applicant: Grimme Landmaschinenfabrik GmbH & Co. KG, Damme (DE)

(72) Inventors: Thomas Brinkman, Neuenkirchen-Vörden (DE); Ralf Heuer, Ankum (DE); Michael Wischmeyer, Venne (DE)

(21) Appl. No.: 19/113,026

(22) PCT Filed: Sep. 18, 2023
(86) PCT No.: PCT/EP2023/075689

§ 371 Date: Mar. 19, 2025

(30) Foreign Application Priority Data
Sep. 19, 2022 (DE) 20 2022 105 281.6

(51) Int. Cl. A01D 33/14; A01D 15/00; A01D 21/00

(52) U.S. Cl. CPC A01D 33/14; A01D 15/00; A01D 21/00

(57) ABSTRACT

A harvesting machine for root crops is provided. The harvesting machine includes a machine frame, with a sieving section designed in particular in the form of a sieving channel and with an adapter for an exchangeable receiving unit. The adapter has an adapter frame designed for fixing the receiving unit and a holding device which is connected to the latter in an articulated manner, extends from the adapter frame along the sieving section and supports the adapter frame on at least one rear part of the machine frame as viewed from a front-side start of the sieving section.

The invention relates to a harvesting machine for root crops, in particular in the form of a trailed or self-propelled digger, with a machine frame, with a sieving section, in particular in the form of a sieving channel, and with an adapter for an exchangeable receiving unit. Furthermore, the invention relates to a receiving unit for a harvesting machine with a receiving frame on which root crop-specific tools for receiving root crops are arranged, and with at least one coupling element for fastening the receiving unit to an adapter frame of a harvesting machine.

Harvesting machines for root crops are used, for example, to harvest different types of potatoes and vegetables, for which it is necessary to adapt the receiving unit, which is arranged at the front of a harvesting machine, to the respective fruit. Harvesting machines are known on the market whose respective receiving unit is mounted on its side facing the front of the harvesting machine and thus to the front. The receiving units are thus pulled from the front. Viewed from the front to the rear, the receiving unit is ad-joined by the sieving section with the sieving channel, which is bounded at the sides in particular by lateral frames, for example, in the form of sieve plates, and at the bottom, for example, by a sieve belt or a roller section. The arrangement of the receiving unit between or at the beginning of the sieving channel and the front bearing limits the installation space for the receiving unit.

It is therefore the task of the present invention to create a harvesting machine that has more installation space for different variants of receiving units.

The problem is solved by a subject matter according to claim 1 and by an object according to claim 16. Advantageous embodiments of the invention can be seen from the sub-claims and the following description.

A harvesting machine according to the invention is characterized in that the adapter has an adapter frame designed to secure the receiving unit and a holding device hingedly connected thereto, which extends from the adapter frame along the sieving section and supports the adapter frame on at least one rear part of the machine frame as viewed from a front-side start of the sieving section. The receiving unit is thus articulated from behind via the holding device running along the sieving section, in particular to the side of the sieving channel. This means that the receiving unit is not limited in the direction of the front of the machine, and receiving units extending forwards differently can be mounted on the same adapter frame, in particular for specific crops and/or depending on the harvesting conditions. Furthermore, assembly and disassembly of the receiving unit is made easier, as the receiving unit is no longer located between the bearing part of the machine frame to which it is attached and the sieving section. In particular, the harvesting machine can be driven up to the receiving unit when it is lying on the ground. This further facilitates assembly.

The front-mounted receiving unit is usually equipped with shares, colter disks and other tools that lift and guide the soil and crop. Due to the holding device running along the sieving section and thus at least substantially horizontally from the receiving unit to the rear, tensile and/or compressive forces generated during operation of the receiving unit are introduced into the machine frame in a straighter line, resulting in better absorption of the forces and less interference. In a side view, at least substantially horizontal here comprises axes between the adapter frame and machine frame-side bearing points of individual links or parts of the holding device, which in particular are angled no more than ±30° to the horizontal surface. The holding device extends along the sieving section in such a way that it absorbs the forces generated in the receiving unit during operation of the harvesting machine within an angle of +30° to the horizontal (corresponding, for example, to a horizontal surface). Due to the holding device running along the sieving section, the machine frame side bearing of the holding device is arranged further towards the end of the harvesting machine than the at least one adapter frame side bearing of the holding device. The longitudinal extension of the holding device does not necessarily run parallel to the sieving channel.

Particularly in the angular ranges described above, but also in other embodiments of the invention, harvesting machines with an additional height guiding device for the adapter frame can result in traverse paths of the adapter frame of 300 mm-900 mm in height.

The machine frame is the frame supporting the harvesting machine, which extends from the connection with a tractor to the rear as far as the chassis in the case of trailed harvesting machines, for example, and transfers the weights of individual functional groups to the chassis or the connection to the tractor.

In order to enable the sieving channel to be pivoted together, the sieving channel is mounted on the front of the adapter frame in accordance with a further development of the invention. For this purpose, parts of the sieving channel, such as a sieving frame, rollers or other parts forming the sieving channel or the sieving section can be attached to the adapter frame. Raising the adapter frame thus simultaneously raises the sieving channel so that the crop to be transferred from the receiving unit to the sieving channel can be passed on appropriately.

Preferably, the holding device forms a double arm guide in a side view of the harvesting machine in such a way that the adapter frame can preferably be adjusted in height without pivoting. In particular, a parallelogram guide of the adapter frame is implemented using the double arm guide. Due to the longitudinal extension of the holding device along the sieving channel, any forces emanating from the receiving unit are nevertheless introduced comparatively horizontally into the machine frame. A double arm guide is a design of the holding device in which at least two links or arms of the double arm guide are arranged at least partially above one another in a side view.

The holding device of the adapter advantageously has at least three links running at least substantially horizontally to a surface and along the sieving section, which are articulated at one end to the machine frame and at the other end to the adapter frame and are connected to one another via the latter. The links, for example in the form of elongated tubes, rods or struts, offer a structurally simple, yet sufficiently stable way of transferring the forces applied in the receiving unit and on the adapter frame along the sieving section further back into the machine frame. To connect the links, the adapter frame is equipped in particular with a cross member and side parts connected to it in one or more parts, each of which is hinged to the holding device.

Preferably, again in a side view, at least two bearings of the links are arranged offset in height relative to each other on the adapter frame, resulting in the double arm guide described. This height offset ensures good absorption of the torques generated in the receiving unit and in the adapter frame during operation, with the height difference between the bearings of different heights of the links being at least 30 cm in particular.

In the side view, the adapter frame is preferably designed in such a way that, in addition to an upper, transverse support, it extends both in the direction of travel and vertically in the side areas, so that an installation space that can be used for the receiving unit is also covered by the adapter frame and the possibility of coupling the receiving unit either laterally and/or from above is realized.

Advantageously, the links comprise at least one upper link and at least one, preferably in particular two, lower links in relation to the adapter frame. It is also possible to use two upper links instead of just one upper link, so that the adapter frame is supported by two links each at the top and bottom. The two lower links extend in particular to the left and right of the sieving channel towards the rear, and the upper link is preferably also located on one side of the adapter frame, so that the design of the sieving channel is obstructed as little as possible. The upper link also extends along the sieving channel. The forces introduced into the frame due to the alignment of the holding device do not place high demands on the flexural rigidity of the holding device.

In particular, the lower links are designed as thrust struts in such a way that a receiving bearing for the receiving unit is at least approximately at the same height as the adapter frame side bearing of the lower links. “At least approximately at the same height” means that the height difference of the respective bearing points in relation to a surface is no more than 10 cm when viewed from the side. The receiving unit is in particular supported on the adapter frame at the same height as the lower link bearing on the adapter frame side. In this respect, at least large parts of the thrust forces generated during operation are transferred to the left and right of the sieving channel into the machine frame.

The upper link, which contributes to the height guidance of the adapter frame in the double arm guide, is designed in particular as a tension strut and is correspondingly subjected to tensile load during operation. Any torques occurring in the receiving unit and in the adapter frame during operation are absorbed and the resulting forces are also transferred to the machine frame, wherein the height guidance of the receiving unit is only minimally affected.

Advantageously, the receiving unit for height guidance has a height guidance device arranged in particular in a front end of the adapter frame. The height guide device is mounted at one end on the adapter frame and held at the other end on the machine frame. One axis running through the bearing points of the height guiding device in particular (in a side view) is advantageously at least approximately perpendicular to an axis running through the bearing points of an upper or a lower link of the holding device.

There is optimum decoupling of the pushing and pulling forces generated during operation of the receiving unit due to the forward movement of the harvesting machine and due to the weight force and the force exerted by the ground. This improves the height guidance of the receiving unit.

The height guide device, for example, comprises cylinder rods holding one side part of the adapter frame, which are part of double-acting cylinders used for height adjustment. Preferably, the upper link is designed as a tension strut to support a torque applied in the receiving unit and the adapter frame during (harvesting) operation of the harvesting machine about an axis running transverse to the direction of travel.

In particular, an adapter frame side bearing of the upper link is offset forwards in the direction of travel in front of the adapter frame side bearings of the lower links. A height guidance arranged in particular at the front ends of the adapter frame has its bearing point as close as possible to the bearing point of the upper links, so that the forces introduced are optimally distributed.

Advantageously, at least some of the parts of the holding device extending along the sieving channel are designed to be adjustable in length. One or more of the links in particular are variable in length, so that the adapter frame can be tilted or pivoted about an axis extending transversely to the direction of travel either before or during operation, which increases the adjustment possibilities of the receiving unit.

For example, the length of the upper link can be adjusted using a threaded rod. The same applies to the lower links.

Preferably, a particularly self-locking locking device for fixing a coupling element of the receiving unit is arranged on the adapter frame. In particular, this holds the coupling element close to an adapter frame side bearing of the holding device. Self-locking is achieved, for example, by a catch hook that is locked in the dead center or over dead center position by means of one or more levers. Automatic actuation of this locking mechanism makes the receiving unit easier to install.

Advantageously, a harvesting machine according to the invention according to the embodiments described above or below also comprises a receiving unit for receiving root crops, in particular potatoes, onions or other vegetables.

Preferably, a receiving frame of the receiving unit and/or the adapter frame is provided with a guide surface that enables or defines a relative positioning of the receiving unit to the adapter frame. The necessary movement of the adapter frame along a guide surface of the receiving unit or vice versa defines a coupling movement along which the interlocking of the adapter frame and any associated parts of the sieving channel takes place without complications. The receiving unit is optimally positioned at the front of the sieving channel.

The task set at the beginning is also solved by a receiving unit for a harvesting machine as described above or below, wherein the receiving unit has a receiving frame on which root crop-specific tools for receiving root crops are arranged, and which has at least one coupling element for fastening the receiving unit in an adapter frame of a harvesting machine. Such a receiving unit is characterized by the fact that the adapter frame has a guide surface with a preferably upper edge in a side view, which slopes down to a bearing area of the adapter frame delimited by a hook.

The bearing area of the adapter frame is formed in particular by hook-shaped areas of side parts of the receiving frame, wherein, in order to attach the receiving unit to the adapter frame, its cross members or any transverse bolts must slide along the guide surface into the bearing area. An area of the guide surface that is higher in the side view makes it necessary to raise the storage frame to bring it closer to a receiving unit lying on the floor, while a sloping area must be lowered to bring the adapter frame into the bearing area. Overall, the adapter frame must be moved towards the receiving unit by a combined vertical and forward movement. Such a movement leads to a lifting of attachments connected to the adapter frame, which then move into the correct position in relation to the receiving unit.

A receiving bearing for the receiving unit in the area of the lower links, which is preferably designed at the same height as the adapter frame side bearings of the lower links on the adapter frame, is located in particular in the effective range of a locking device, which, for example, grips coupling elements mounted on side struts of the receiving frame, for example, in the form of bolts, with a catch hook and holds them close to the lower link bearing.

Further advantages and details of the invention can be found in the following description of the figures. Schematically shown:

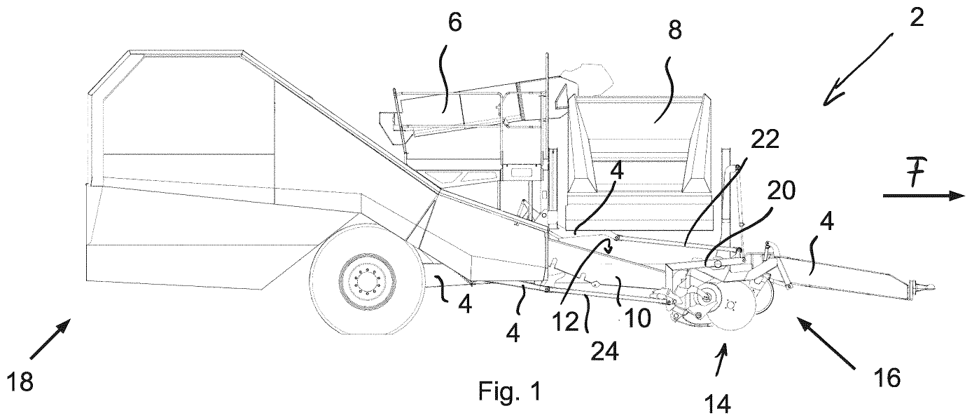

FIG. 1 a side view of an object according to the invention,

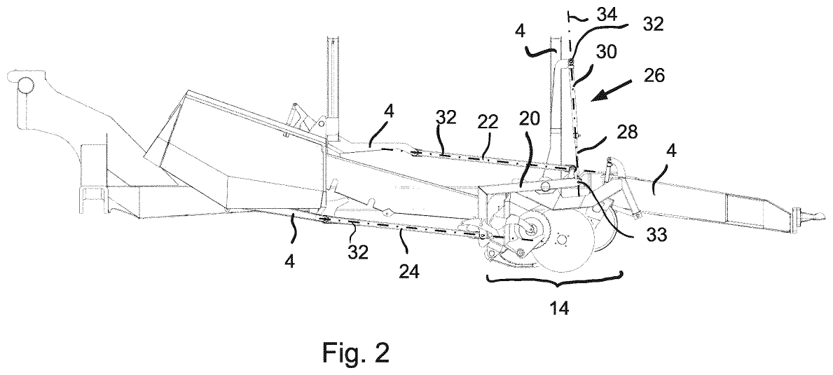

FIG. 2 a partial view of the object shown in FIG. 1,

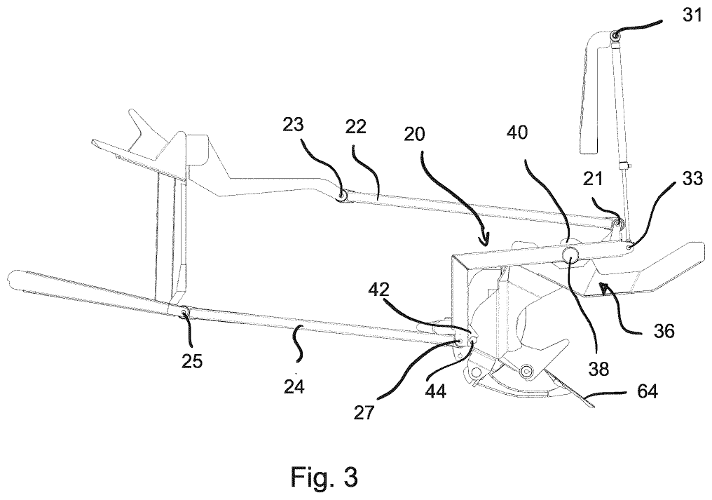

FIG. 3 a further simplified partial view of the object shown in FIG. 2,

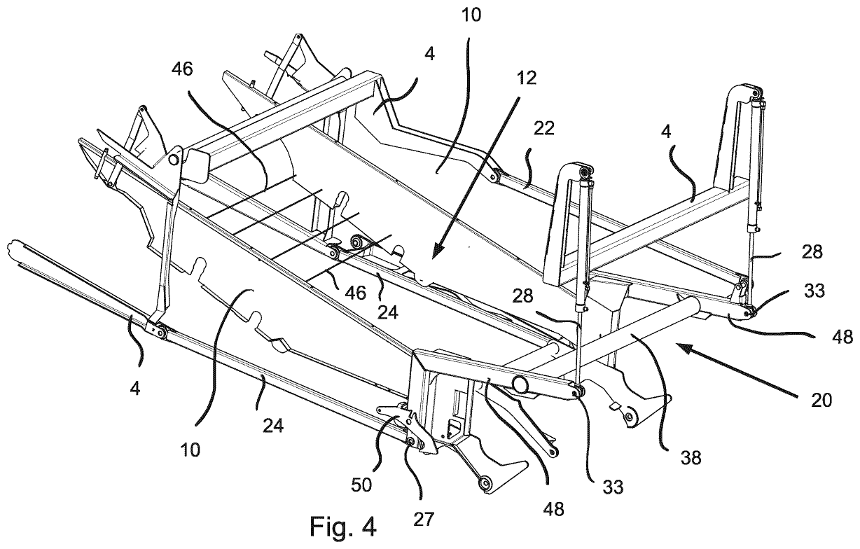

FIG. 4 another partial view of the object shown in FIG. 2,

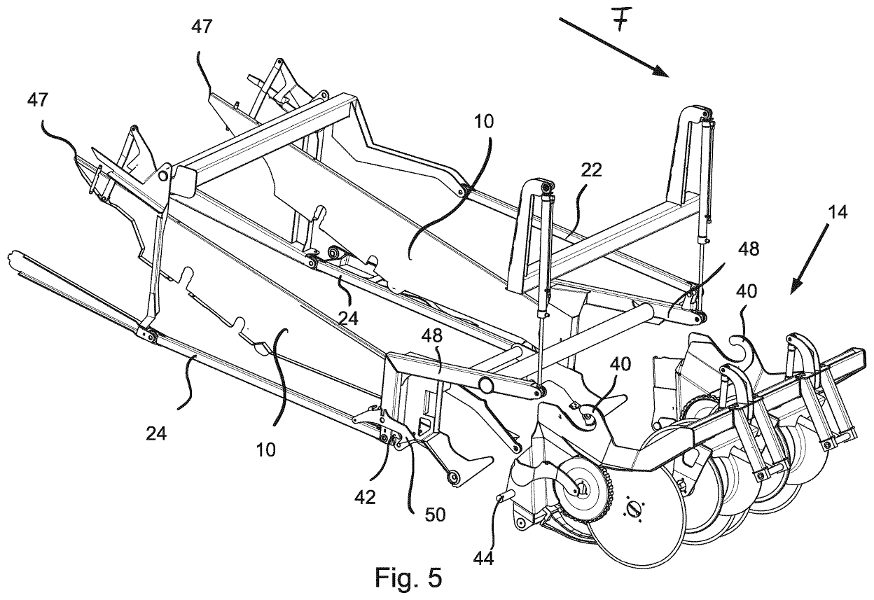

FIG. 5 a further partial view of the object according to the invention,

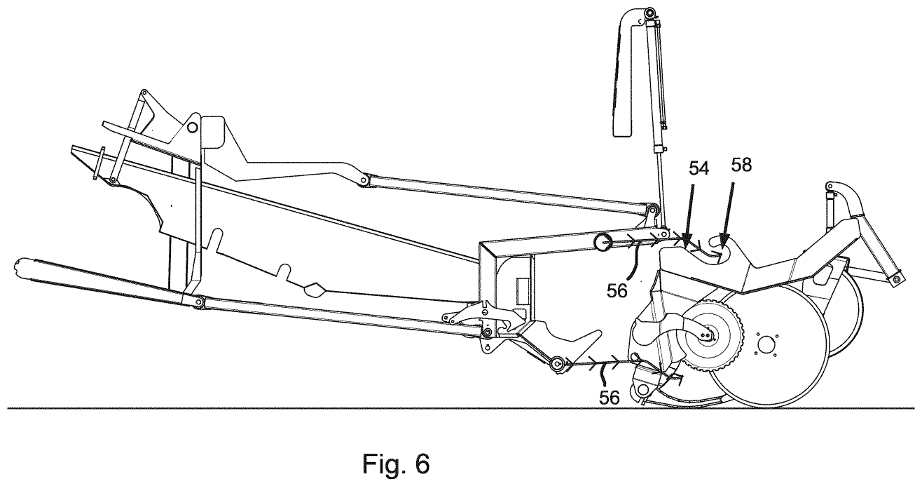

FIG. 6 another view of the object shown in FIG. 5,

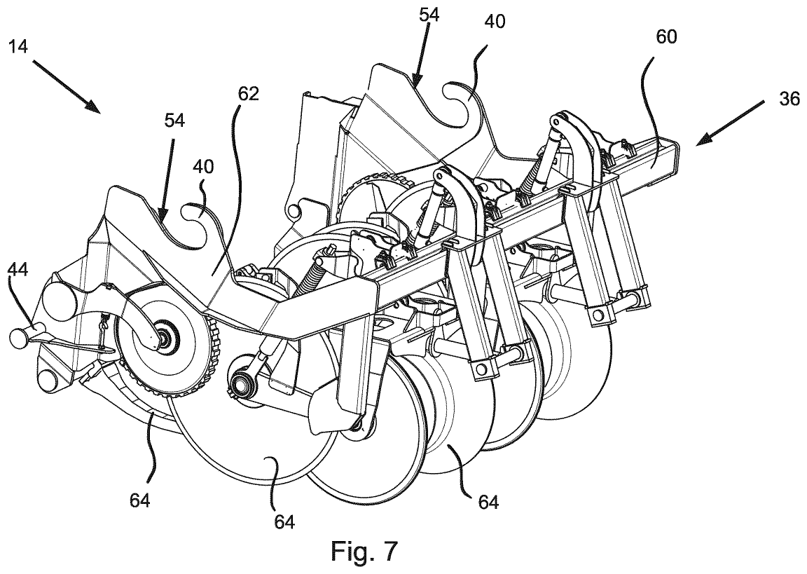

FIG. 7 another object according to the invention.

Individual technical features of the embodiments described below can also be combined with the embodiments described above and the features of one of the independent claims and any further claims to form articles according to the invention. Where appropriate, identical reference numbers are assigned to elements that have at least partially the same function.

A harvesting machine 2 according to the invention for root crops, in the present case in the form of potatoes, is designed as a trailed potato lifting machine. The harvesting machine 2 has a machine frame 4, which has functional elements of the harvesting machine such as upper separators 6, a bunker 8 and a sieving channel 12 formed behind and from a side plate 10. The sieving channel 12 is bounded by two side plates 10, begins in the area of a receiving unit 14 and runs slightly upwards from the front 16 of the harvesting machine 2 towards the rear end 18 of the harvesting machine 2 (FIG. 1).

The receiving unit 14 is fixed by means of an adapter. The adapter comprises an adapter frame 20, which is supported on the machine frame side in bearings 23 and 25 via a holding device, which comprises an upper link 22 and two lower links 24 and extends along the sieving channel 12 from the receiving unit to the rear. At the same time, the adapter frame is hinged to the holding device.

The upper link 22 and the lower links 24 form a parallelogram guide in the side view according to FIG. 2, i.e., the link lengths of the upper and lower links are identical in this case, wherein the vertical distances between the bearings 23 and 25 on the machine frame side and the bearings 21 and 27 on the adapter frame side, projected onto a perpendicular to the surface, are also the same (see FIGS. 2 and 3). Axes 32 through the bearings of the respective links run parallel. Nevertheless, according to the invention and any further embodiments, it may be provided to make the upper and/or lower links variable in length, whereupon the parallelogram guide is reduced to a double arm guide, which is accompanied by a pivoting of the adapter frame 20 and an associated pivoting of the receiving unit 14.

A height guide device 26 comprises a piston rod 28, which is guided in a double-acting cylinder 30 and is also fixed on the machine frame side. The axis 32 extending through the respective bearings 21 and 23 of the upper link 22 and the axis 34 extending through the bearings 31 and 33 of the height guide device 26 are (in a side view) at least approximately perpendicular, i.e., at an angle of 85° to 105°, preferably at an angle of 80° to 100° to each other, which results in an effective separation of the force flows due to the receiving unit 14 moving through the ground. For this purpose, the holding device is designed as a double arm guide, with the lower links 24 also having correspondingly extending axes 32.

In general, the holding device extends over at least 30 %, preferably over at least 50 % of the sieving section, i.e., the length of the sieving channel 12 or the sieving belt on which it is based, from the front towards the rear (in relation to a projection onto the surface), so that even when the height of the receiving unit is adjusted due to the height guide device 26, the holding device formed by the upper links and lower links 22 and 24 continues to transmit tensile or shear forces applied almost horizontally in the receiving unit 14 when the receiving unit 14 is moved through the ground into the machine frame. During harvesting operation of a harvesting machine 2 of the invention provided with a receiving unit 14, a receiving frame 36 is connected to the adapter frame 20 via hooks 40 held on a cross member 38 and via coupling elements 44 in the form of bolts lying in receiving bearings 42. In addition to the cross member 38, the adapter frame 20 has side parts 48 (cf. FIGS. 3 and 4), which connect the upper link 22 and the lower links 24. The sieving channel 12 runs between the side plates 10, which are mounted on the adapter frame 20. In order to enable a height adjustment of generally up to 60% by the height guide device 26 without exerting too much pressure on the side plates 10, these are floatingly mounted at their end 47 located towards the rear end of the harvesting machine 2. Both the lower links 24 and the upper link 22 run laterally of the sieving channel 12, which is limited at the bottom by indicated sieving bars 46. The side plates represent a part of the sieving frame which carries, for example, rollers on which the screen belts, which have the sieving bars 46 and are not shown in detail here, are carried.

In addition to the cross strut 38, the adapter frame 20 comprises side parts 48, at the front end of which the piston rods 28 are mounted to engage. A catch hook 50 is part of a locking device, via which the coupling element 44 is held close to the bearing 27 of the lower link 24 in order to enable optimum introduction of the horizontal forces into the machine frame 4 via the lower links 24. The lower links 24 are also designed to absorb transverse forces acting transverse to the direction of travel F, which are transmitted from the receiving unit 14 to the adapter frame 20, particularly during harvesting operation.

The side parts 48 of the adapter frame extend in a lower region substantially from bottom to top and bend in an upper region almost horizontally in a forward direction towards the cross strut 38 and towards the bearings of the height guide device 26, thereby overlapping an installation space for the receiving unit 14 in a side view (FIGS. 2 and 5). Thus, the adapter frame 20 can be guided from the rear in the direction of travel F towards the front of the receiving unit 14 in such a way that the cross strut 38 according to FIG. 6 is guided along a guide surface 54, which is formed by the surface of the side parts 48 and corresponds to an upper edge of the side parts in a side view, in such a way that functional parts are correctly positioned according to the movement path 56 partly within the installation space of the receiving unit 14. Accordingly, the side part 48 is formed with a raised edge in an area that is no longer required statically, which slopes down to the bearing area 58 bounded by the hook 40.

FIG. 7 shows a receiving unit 14 according to the invention, which is designed for attachment to an adapter frame 20 of a harvesting machine 2 described above. For this purpose, the receiving frame 36 has a receiving cross member 60, on which receiving side parts 62 are arranged. These carry the coupling elements 44 used for attachment to the adapter frame and form the hooks 40. Different tools 64, for example, in the form of shares, colter disks or dam drums, can be attached to the receiving frame 36 depending on the root crop.

1. A harvesting machine for root crops, the harvesting machine comprising:
a machine frame with a sieving section and with an adapter for an exchangeable receiving unit;
the adapter having an adapter frame fixing the receiving unit with a holding device connected to the frame in an articulated manner, the holding device extending from the adapter frame along the sieving section and supporting the adapter frame on at least one rear part of the machine frame as viewed from a front-side start of the sieving section.

2. The harvesting machine according to claim 1, wherein the sieving channel is mounted on the front of the adapter frame.

3. The harvesting machine according to claim 1, wherein holding device forms a double arm guide of the adapter frame in a side view of the harvesting machine.

4. The harvesting machine according to claim 1, wherein the holding device of the adapter has at least three links extending at least substantially horizontally to a surface and along the sieving section, which links are mounted at one end in an articulated manner on the machine frame and at the other end in an articulated manner on the adapter frame and are connected to one another via the latter.

5. The harvesting machine according to claim 4, wherein in a side view, at least two bearings of the links are arranged offset in height relative to one another on the adapter frame.

6. The harvesting machine according to claim 3, wherein the links form at least one upper link and at least one lower link in relation to the adapter frame.

7. The harvesting machine according to claim 6, wherein the at least one lower link includes two lower links, wherein the lower links are thrust struts such that, in a side view, a receiving bearing for the receiving unit is at least approximately at the same level as the adapter frame side bearing of the lower links.

8. The harvesting machine according to claim 6, wherein the upper link is arranged on one side of the adapter frame.

9. The harvesting machine according to claim 6, wherein the upper link is a tension strut for supporting a torque occurring in the receiving unit and the adapter frame during operation of the harvesting machine about an axis extending transversely to the direction of travel.

10. The harvesting machine according to claim 6, wherein an adapter frame side bearing of the upper link is arranged offset forwards in the direction of travel in front of the adapter frame side bearings of the lower links.

11. The harvesting machine according to claim 1, wherein height guiding device is arranged at a front end of the adapter frame.

12. The harvesting machine according to claim 1, wherein at least some of the parts of the holding device extending along the sieving channel are variable in length.

13. The harvesting machine according to claim 1, wherein a locking device for fixing a coupling element of the receiving unit is arranged on the adapter frame.

14. The harvesting machine according to claim 1, comprising a receiving unit for picking up root crops.

15. The harvesting machine according to claim 14, wherein a receiving frame of the receiving unit and/or the adapter frame have a guide surface for relative positioning with respect to one another.

16. A receiving unit for a harvesting machine according to claim 1, the receiving unit comprising:
a receiving frame on which root crop-specific tools for receiving root crops are arranged;
at least one coupling element for fastening the receiving unit in an adapter frame of the harvesting machine;
wherein the adapter frame has a guide surface with an upper edge in a side view, which slopes down to a bearing area of the adapter frame delimited by a hook.

17. The harvesting machine according to claim 1, wherein the sieving section is a sieving channel.

18. The harvesting machine according to claim 3, wherein the holding device forms a parallelogram guide of the adapter frame in a side view of the harvesting machine.

19. The harvesting machine according to claim 18, wherein the adapter frame is adjustable in height without pivoting.

20. The harvesting machine according to claim 13, wherein the locking device is a self-locking device.
